(19) United States
(12) Patent Application Publication
(10) Pub. No.: US 2004/0129377 A1
(43) Pub. Date: Jul. 8, 2004

(54) Storage labels having write on surface

(76) Inventor: Ashley Felder, Simi Valley, CA (US)

Correspondence Address: Colin P. Abrahams, Suite 400, 5850 Canoga Avenue, Woodland Hills, CA, 91367, US

(21) Appl. No.: 10/338,468

(22) Filed: Jan. 8, 2003

(51) Int. Cl. B32B 31/00

(52) U.S. Cl. 156/247; 40/299.01

(57) ABSTRACT

A write on label device comprises a label having an upper surface and lower surface. A write on surface formed on the upper surface of the label, with the write on surface being receptive to markings from a wide variety of writing implements substantially without smudging of the marking. An adhesive layer is formed over at least a portion of the lower surface of the label and has properties which allow peel off removal of the label from a surface on which it is mounted.

### FIELD AND BACKGROUND OF THE INVENTION

This invention relates to storage labels having a write-on surface. Particularly, the invention is for a label which is specifically designed to be applied to items which may be stored, with the label having a specially treated surface which can be written upon by most types of writing implements.

Various sorts of labels, tapes, signs and other forms of adhesive identifiers are well known, and used widely in a range of applications. Thus, labels may be applied to bottles, books, files, storage media and a very large number of other products, with the label typically having a lower surface on which is formed an adhesive by means of which it can be applied to the product, and an upper surface which may be used for writing on in order to identify the article, package or product as desired. A large number of labels are shown in the prior art, and some of these are discussed below.

U.S. Pat. No. 4,671,003 (Vitol) discloses an easily removable label which is designed to be easily removable and reusable.

U.S. Pat. No. 5,597,634 (Bloomer) describes “changeable media labels”, comprising a label pad which may be applied to a video cassette, for example. The top layer can be peeled off, exposing an unused layer beneath that, when new labeling is required.

U.S. Pat. No. 5,195,265 (Klingenberg) also describes a pad stack of labels, designed for easy removal of single labels from the stack.

U.S. Pat. No. 4,060,168 (Romagnoli) has a strip of backing material with labels serially arranged thereon, with adhesive selectively applied so that when the label is removed from an object, a printed message ism shown.

U.S. Pat. No. 4,973,088 (Levy) shows another form of stacked paper labels, this time for use on media such as floppy disks.

European Patent Application No. EP 0 725 378 is for a reusable self-adhesive label, also for use on a recording medium such as a cassette tape, a video tape, discs, cartridges and the like.

Other examples of the prior art can be seen in U.S. Pat. No. 5,868,431 (Dudley); U.S. Pat. No. 5,683,775 (Franklin); U.S. Pat. No. 5,824,379 (Riley); and U.S. Pat. No. 5,658,631 (Bernstein).

As will be appreciated, large numbers of different labeling systems, signs and tape are available, each intended for a specific purpose and designed for optimal use in a particular application.

### SUMMARY OF THE INVENTION

According to one aspect of the invention, there is provided a write on label device comprising: a label having an upper surface and lower surface; a write on surface formed on the upper surface of the label, the write on surface being receptive to markings from a wide variety of writing implements substantially without smudging of the marking; and an adhesive layer over at least a portion of the lower surface of the label, the adhesive surface having properties which allow peel off removal of the label from a surface on which it is mounted.

Preferably, the label is comprised of a plastic material. The write on surface may cover only a portion of the upper surface of the label. Further, the write on surface may be visible and comprise a specific shape, or it may have a color which contrasts with that of the label.

In one form of the invention, the labels comprise a plurality of labels stacked to form a booklet. Alternatively, the labels are mounted serially on a continuous strip backing which is formed into a roll.

The adhesive layer may be formed over the entire lower surface of the label and a deadener is applied to a strip of adhesive along an edge of the label, or the lower surface of the label may have an absence of the adhesive layer along one edge thereof with the remainder of the lower surface of the label having an adhesive layer thereon. Preferably, the adhesive layer and the write on surface are comprised of a material having properties which make them resistant to temperatures below freezing.

Preferably, the write on surface is receptive to markings from writing implements selected from: ballpoint pens, pencils, roller ball pens, gel pens, marker pens, felt pens, fountain pens, and highlighter pens.

According to another aspect of the invention, there is provided a write on label device comprising: a label having an upper surface and lower surface; a write on surface formed on the upper surface of the label, the write on surface being receptive to markings from a wide variety of writing implements substantially without smudging of the marking; an adhesive layer over at least a portion of the lower surface of the label, the adhesive surface having properties which allow peel off removal of the label from a surface on which it is mounted; and a non-adhesive stip on the lower surface of the label to facilitate removal of the label from a surface.

According to yet another aspect of the invention, there is provided a method of labeling an article for storage comprising: forming a label having an upper surface and lower surface, a write on surface on the upper surface of the label which is receptive to markings from a wide variety of writing implements substantially without smudging of the marking, and an adhesive layer over at least a portion of the lower surface of the label which has properties which allow peel off removal of the label from a surface on which it is mounted; forming a non-adhesive strip on the lower surface of the label to facilitate removal of the label from a surface; removing the label from a backing surface by raising the non-adhesive strip away from the backing strip; and adhering the label having written material on the write on surface to an article to be stored.

The present invention is directed to a label which, in general terms, has an adhesive on one side so that the label can be fastened to an article, and, on the other side, a surface which is treated or prepared such that it can be written on by most types of writing implements. Preferably, the label of the invention is formed of a plastic material, and, in a preferred embodiment, is used to label products which will be stored in more extreme environmental conditions, such as in very wet or high moisture conditions, very cold conditions, such as in a freezer, or in warm conditions.

In one aspect of the invention, the label of the invention has adhesive over most of its lower surface, but, adjacent at least one of the edges, there is an absence of adhesive to facilitate removal of the label either from the backing on which it is mounted for storage or from the article, once it is no longer needed. The absence of adhesive will, as will be appreciated, enable the user to easily lift at least a small portion of the label using a fingernail, which will be sufficient to obtain a grip on the label so as to thereafter remove the entire label more easily.

In another form of the invention, the upper surface of the label, or at least a portion thereof, is specially treated with a material which is particularly receptive and effective for receiving writing from a wide variety of writing implements. The label, which is preferably plastic, can thus be easily marked up, without having to search for an appropriate writing implement. This is of particular value when, for example, the label is intended to be used on an article to be stored in a refrigerator or freezer. Such labels are almost always comprised of a plastic material so that they will be able to resist moist and cold conditions, and plastic surfaces usually are difficult to write on, especially with certain writing implements, such as pencils, gel or roller pens. Even if these types of writing implements do mark the surface of the label, such markings are often smudged or rubbed off if subjected to moisture or rubbing. In fact, for the most part, only ballpoint pens are effective to write on many of these surfaces which are comprised of plastic, and even ballpoint pens sometimes do not mark the tape legibly or consistently, especially in a way which would be retained in extreme conditions, such as moist and cold.

A plurality of labels in accordance with the invention may be stacked in book-like or booklet form, so that a single label can be peeled off the top and applied to an article or product, as desired, and when needed. Upon application to the product, the specially treated surface can be written upon, easily with most writing implements, and the article stored.

When applying the label to the stored article, it can be peeled off the booklet, and the lower surface which has the adhesive then placed on the article or product. The absence of the adhesive along a portion of the undersurface of the label, and preferably a side edge thereof, facilitates removal of the label from the stack, and, later, removal of the label from the stored article or product.

The label of the invention therefore provides an effective and efficient method of temporarily labeling an article which will be stored in more extreme conditions.

One important application of the invention relates to storage of food or other products within a refrigerator or freezer. Often foods are bought in bulk, and the labeling system of the invention enables each product or item to be dated and identified in a simple manner before being placed in the refrigerator. The invention is also of particular use in preparing, for example, babies' bottles. Such bottles may be prepared in large numbers for future use, and appropriate labeling, including date and content, is not only useful for later identification, but also for safety and hygiene purposes so that old or stale preparations will not be used.

While the invention has many applications, it is of particular use in storing items in a refrigerator or freezer. These items are stored under extreme cold, and often in moisture conditions as well. Conventional labels are generally not able to withstand such conditions. At the same time, the labels of the invention may have portions thereon which are specially treated so that items to be stored can be marked and identified at a later time.

### BRIEF DESCRIPTION OF THE DRAWINGS

FIG. 1 is a diagrammatic top view of a label in accordance with the invention;

FIG. 2 is a diagrammatic bottom view of a label in accordance with the invention;

FIG. 3 is a diagrammatic side view of a label shown in FIG. 1 of the drawings;

FIG. 4 shows a plurality of stacked labels in book form, the labels being in accordance with the invention as shown in FIG. 1 of the drawings; and

FIG. 5 shows label in accordance with the invention placed on a continuous strip, which is then formed as a roll for storage of the labels until needed.

### DETAILED DESCRIPTION OF THE INVENTION

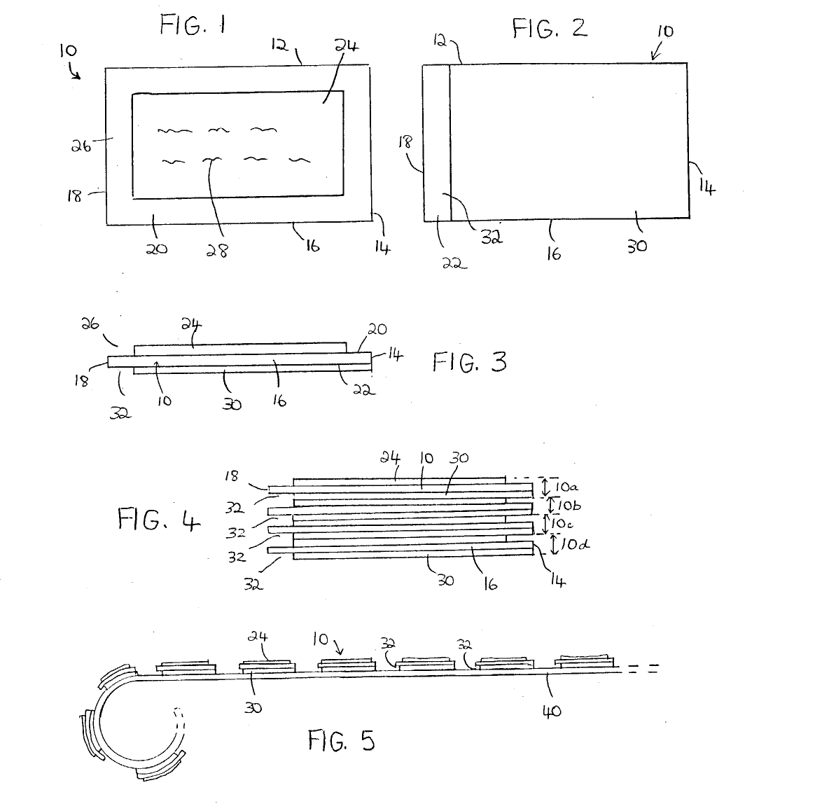

Reference is now made to the drawings. FIG. 1 of the drawings shows a top view of a label 10 in accordance with the invention. The label 10 has side edges 12, 14, 16 and 18, and an upper surface 20. A lower surface 22 can be seen in FIG. 2 of the drawings. The label 10 shown in FIG. 1 is preferably comprised of a plastic, plastic laminate and/or a water and moisture resistant material.

The upper surface 20 of the label 10 includes a writing patch 24, which is generally of rectangular shape, similar to that of the label 10, but slightly smaller. A peripheral border 26 is formed between the writing patch 24 and the edges 12, 14, 16 and 18 of the label.

It will be appreciated that the writing surface 24 shown in FIG. 1 of the drawings is generally rectangular in shape, but a writing patch of any size and shape can be used. Thus, the writing patch 24 may cover the entire upper surface 20, or only a portion thereof, the portion being of any desired shape and size which may be useful in a particular application. The writing surface 24 may be patterned, such as heart-shaped, bottle-shaped etc. and it may be any color or combination of colors. The color, shape and size of the writing surface may be matched to the article it is intended to identify, such as, for example, a baby's bottle. Further, the color or shape may correlate to the time, such as week or month, by which the item (especially a food item) must be used.

The writing patch 24 includes written identifying information 28, which is written onto the writing patch 24 by a user prior to (or even after) applying the label to an article or product.

In FIG. 2 of the drawings, the label 10 is shown in a bottom view, and the lower surface 22 has an adhesive 30 over most of its surface. Along the edge 18, there is formed a non-adhesive strip 32, which, as its name implies, does not normally adhere to any surface. In forming the non-adhesive strip 32, this may be achieved by either not applying any adhesive to that strip in the production process, or, in the alternative, applying a deadener over adhesive which may have been previously placed thereon during manufacture.

With reference to FIG. 3 of the drawings, there is shown the label illustrated in FIGS. 1 and 2, in side view, and, in order to convey and identify the various layers, the relative thicknesses have been exaggerated and are not to scale. In FIG. 3, the label 10 has on its upper surface 20 the writing patch 24, and on its lower surface 22 the adhesive 30. FIG. 3 illustrates the non-adhesive strip 32 formed along the edge 18, which enables the user to more easily peel the label from a backing on which it is mounted prior to use, or from an article or product on which it is subsequently mounted by simply placing the fingernail under the non-adhesive strip 32 so as to get a grip on the label 10, and remove it, as appropriate.

FIG. 4 shows a stack or book of labels, as shown in FIGS. 1, 2 and 3 of the drawings. Thus, FIG. 4 shows four vertically stacked labels 10a, 10b, 10c and 10d (a typical new stack would, of course, have many more than four labels). Each of the labels is identical, and is also the same as that illustrated in FIG. 3 of the drawings. It will be seen that the stacked labels present a booklet for use, so that labels are readily available, and can be easily peeled off and applied to an article or item which is to be stored, or which is to be labeled, as desired.

FIG. 5 shows a series of labels 10 of the invention mounted on a continuous backing strip 40. The backing strip 40 is formed into a roll, and this is an alternative method of storing a plurality of labels 10, as compared to the stacked booklet form shown in FIG. 4. As labels 10 are needed, the leading end of the backing strip 40 is unrolled, and labels 10 which are serially mounted thereon can be removed as needed. It will be seen that the nonadhesive strip 32 allows an edge of the label 10 to be easily lifted from the backing strip 40 using a fingernail, for example, making the label more user friendly.

The label of the invention may be manufactured in a variety and assortment of shapes and sizes. In one form, the labels may be made on a conventional 8×11½ sheet of paper, with peel off segments. Such a sheet may have 2, 4, 8 or 16 labels per page, or, indeed, any other convenient number.

Smaller labels may be used for drinking cups, especially sipper type cups used by young children. This would be particularly useful at schools or playgroups for children. Furthermore, drink labels may applied to plastic or glass cups at birthday parties, adult or college parties to avoid mixing up drinks and the confusion caused by large numbers of identical or similar types of drinking containers common at functions.

The labels may also be used on Tupperware®, Rubbermaid®, Gladware® of similar types of containers to identify food, such as by date stored. The labels can easily be removed after use and discarded, with no damage or residue being left on the container.

The labels of the invention are very useful for marking wiring for electronic applications, and to identify electric cords or wires for computers and peripheral equipment as well as for appliances. The labels are also practical and beneficial in doctors' offices and laboratories for temporarily labeling test tubes and other types of equipment. They may be used in the re-using and/or recycling of VHS tapes and other media, to allow for multiple removals when the media are used for recording different movies, audio etc. Also, make up artists and general artists need to label their make up because it may often expire. Artists' labeling paint containers, brushes and the like may also benefit from use of the labels of the invention.

The invention is not limited to the precise details of construction as described above and illustrated in the accompanying drawings. Variations are possible within the scope of the invention. Preferably, the adhesive used on the lower surface of the label 10 is one which is not of a permanent nature so that the use of a label on an article or product, as well as on the backing strip or on other labels in the booklet form, makes it easily removable without leaving any sticky residue or stain. Such adhesives are well known in the art and any such adhesive which will fulfill the f8nctions and requirements of the invention will be suitable.

Further, the writing surface on the upper surface of the label is selected so that it will receive and hold in a relatively permanent manner the markings of any common household writing implement.

1. A write on label device comprising:
a label having an upper surface and lower surface;
a write on surface formed on the upper surface of the label, the write on surface being receptive to markings from a wide variety of writing implements substantially without smudging of the marking; and
an adhesive layer over at least a portion of the lower surface of the label, the adhesive surface having properties which allow peel off removal of the label from a surface on which it is mounted.

2. A label device as claimed in claim 1 wherein the label is comprised of a plastic material.

3. A label device as claimed in claim 1 wherein the write on surface covers only a portion of the upper surface of the label.

4. A label as claimed in claim 3 wherein the write on surface is visible and comprises a specific shape.

5. A label as claimed in claim 3 wherein the write on surface has a color which contrasts with that of the label.

6. A label device as claimed in claim 1 wherein the labels comprise a plurality of labels stacked to form a booklet.

7. A label device as claimed in claim 1 wherein the labels are mounted serially on a continuous strip backing which is formed into a roll.

8. A label device as claimed in claim 1 wherein the adhesive layer is formed over the entire lower surface of the label and a deadener is applied to a strip of adhesive along an edge of the label.

9. A label device as claimed in claim 1 wherein the lower surface of the label has an absence of the adhesive layer along one edge thereof with the remainder of the lower surface of the label having an adhesive layer thereon.

10. A label as claimed in claim 1 wherein the adhesive layer is comprised of a material having properties which make it resistant to temperatures below freezing.

11. A label as claimed in claim 1 wherein the write on surface is comprised of a material having properties which make it resistant to temperatures below freezing.

12. A label as claimed in claim 1 wherein the write on surface is receptive to markings from writing implements selected from: ballpoint pens, pencils, roller ball pens, gel pens, marker pens, felt pens, fountain pens, and highlighter pens.

13. A write on label device comprising:
a label having an upper surface and lower surface;
a write on surface formed on the upper surface of the label, the write on surface being receptive to markings from a wide variety of writing implements substantially without smudging of the marking;
an adhesive layer over at least a portion of the lower surface of the label, the adhesive surface having properties which allow peel off removal of the label from a surface on which it is mounted; and
a non-adhesive stip on the lower surface of the label to facilitate removal of the label from a surface.

14. A label as claimed in claim 12 wherein the write on surface is receptive to markings from writing implements selected from: ballpoint pens, pencils, roller ball pens, gel pens, marker pens, felt pens, fountain pens, and highlighter pens.

15. A label as claimed in claim 12 wherein the adhesive layer and the write on surface are comprised of a material having properties which make them resistant to temperatures below freezing.

16. A method of labeling an article for storage comprising:
forming a label having an upper surface and lower surface, a write on surface on the upper surface of the label which is receptive to markings from a wide variety of writing implements substantially without smudging of the marking, and an adhesive layer over at least a portion of the lower surface of the label which has properties which allow peel off removal of the label from a surface on which it is mounted;
forming a non-adhesive strip on the lower surface of the label to facilitate removal of the label from a surface;
removing the label from a backing surface by raising the non-adhesive strip away from the backing strip; and
adhering the label having written material on the write on surface to an article to be stored.
